(19) United States
(12) Patent Application Publication
(10) Pub. No.: US 2009/0040188 A1
(43) Pub. Date: Feb. 12, 2009

(54) TERMINAL HAVING TOUCH SCREEN AND METHOD OF PERFORMING FUNCTION THEREOF

(76) Inventor: Se Youp CHU, Gumi-si (KR)

Correspondence Address: CHA & REITER, LLC, 210 ROUTE 4 EAST STE 103, PARAMUS, NJ, 07652, US

(21) Appl. No.: 12/141,963

(22) Filed: Jun. 19, 2008

(30) Foreign Application Priority Data
Aug. 8, 2007 (KR) 2007-0079443

(51) Int. Cl. G06F 3/041

(52) U.S. Cl. 345/173

(57) ABSTRACT

A terminal having a touch screen and a method of performing functions in accordance with the touch screen. The method of performing a function of a terminal having a touch screen includes: detecting movement of a focus for performing the function; and performing, if a detected touch is generated on the touch screen, a function corresponding to a position to which the focus is moved. A touch for performing a function can be generated in a greater area of a terminal having a touch screen, so that generation of erroneous operations due to a small size of the touch screen can be avoided.

### CLAIM OF PRIORITY

This application claims priority to an application entitled “TERMINAL HAVING TOUCH SCREEN AND METHOD OF PERFORMING FUNCTION THEREOF” filed in the Korean Intellectual Property Office on Aug. 8, 2007 and assigned Serial No. 2007-0079443, the contents of which are incorporated herein by reference in its entirety.

### BACKGROUND OF THE INVENTION

1. Field of the Invention

The present invention relates to a terminal having a touch screen and a method of performing a function thereof. More particularly, the present invention relates to a terminal having a touch screen and a method of performing a function thereof for reducing erroneous operation by a touch generated by a user in a wide area when a focus is positioned in a specific function and a touch for performing the generation of a corresponding function.

2. Description of the Related Art

In general, a touch screen of a terminal provides a user interface in which a user can input information or an instruction to the terminal through touch for a variety of functions. The touch screen is applied to various terminals such as a mobile phone, smart phone, palm personal computer, and Personal Digital Assistant. Further, nowadays, as there has been a trend to decrease the size and weight of the terminal, the size and weight of the touch screen have also gradually decreased.

When the functions of a terminal having a touch screen are expanded to include enhanced information processing, the terminal has several restricting factors due to its intrinsic characteristic, whereby several difficulties exist in operating the terminal. Particularly, as the size of an external body of the terminal decreases, the size of a display screen thereof also decreases, and thereby it is inconvenient for the user to select and input necessary information.

In other words, in order to perform a function on the touch screen, the user should move a focus and touch an area at which the focus is displayed. However, it is difficult to generate touch precisely on a small touch screen. When several different functions are arranged at a narrow separation intervals, erroneous operations are frequently generated instead of the desired function based the wrong area of the screen touched.

### SUMMARY OF THE INVENTION

The present invention has been made to provide a terminal having a touch screen and a method of performing a function thereof that performs a function corresponding to a position on the touch screen to which a focus is moved, for example, by moving the focus using a direction key and generating a touch in any area of the touch screen.

The present invention also provides a terminal having a touch screen and a method of performing a function thereof that corresponds to a position on the touch screen to which a focus is moved, for example, by moving the focus using a flick and hold action and generating a touch and drop action in any of a position to which the focus is moved and an idle area in the touch screen.

The present invention also provides a terminal having a touch screen and a method of performing a function thereof that corresponds to a position on the touch screen to which a focus is moved, for example, by moving the focus using a flick and hold action and generating a touch and drop action in any area of the touch screen.

In accordance with one aspect of the present invention, a method of performing a function of a terminal having a touch screen typically includes: moving a focus for performing the function; and performing, if a touch is generated on the touch screen, a function corresponding to a position to which the focus has been moved.

In accordance with another aspect of the present invention, a terminal typically includes: a touch screen; and a controller for controlling to move a focus for performing a function and to perform, if a touch is generated on the touch screen, a function corresponding to a position to which the focus is moved.

### BRIEF DESCRIPTION OF THE DRAWINGS

The above features and advantages of the present invention will be more apparent from the following detailed description in conjunction with the accompanying drawings, in which:

FIG. 1 is a block diagram illustrating a configuration of a terminal having a touch screen for performing a function according to an embodiment of the present invention;

FIG. 2 is a flowchart illustrating a method of performing a function of a terminal according to another embodiment of the present invention;

FIGS. 3A and 3B are diagrams illustrating a screen for performing a specific function in the method of FIG. 2;

FIG. 4 is a flowchart illustrating another method of performing a function of a terminal according to another embodiment of the present invention;

FIGS. 5A and 5B are diagrams illustrating an exemplary screen for performing a specific function in the method of FIG. 4; and

FIG. 6 is a flowchart illustrating another exemplary method of performing a function of a terminal according to another embodiment of the present invention.

### DETAILED DESCRIPTION

Now, embodiments of the present invention are described with reference to the accompanying drawings in detail. The same reference numbers are used throughout the drawings to refer to the same or like parts. For the purposes of clarity and simplicity, detailed descriptions of well-known functions and structures incorporated herein may be omitted to avoid obscuring the appreciation of the subject matter of the present invention.

In an exemplary embodiment of the present invention, a term “touch” typically indicates a state in which a user's hand or a stylus comes in contact with a touch screen. That is, the term “touch” includes both ‘flick and hold’ and ‘touch and drop’. The term “flick and hold” typically indicates an action in which the user quickly moves a finger or a stylus on the touch screen, then stops and holds the finger or stylus on the touch screen, similar to drawing a line. Further, the term “touch and drop” typically indicates an action in which the user touches the touch screen using the finger or the stylus, then releases the touch from the touch screen.

For convenience of description, examples of a terminal according to the present invention is shown herein, however the present invention is not limited thereto. In other words, although a terminal according to an exemplary embodiment of the present invention has a touch screen as shown and described, the invention is not limited to such illustrations and their accompanying descriptions herein. For example, the terminal can be applied to information and communication appliances and multimedia appliances such as a mobile terminal, mobile phone, wire/wireless phone, Portable Multimedia Player, Personal Digital Assistant, smart phone, and notebook computer and personal computer, and applications thereof, just to same a few of the many variations that are within the spirit and scope of the claimed invention.

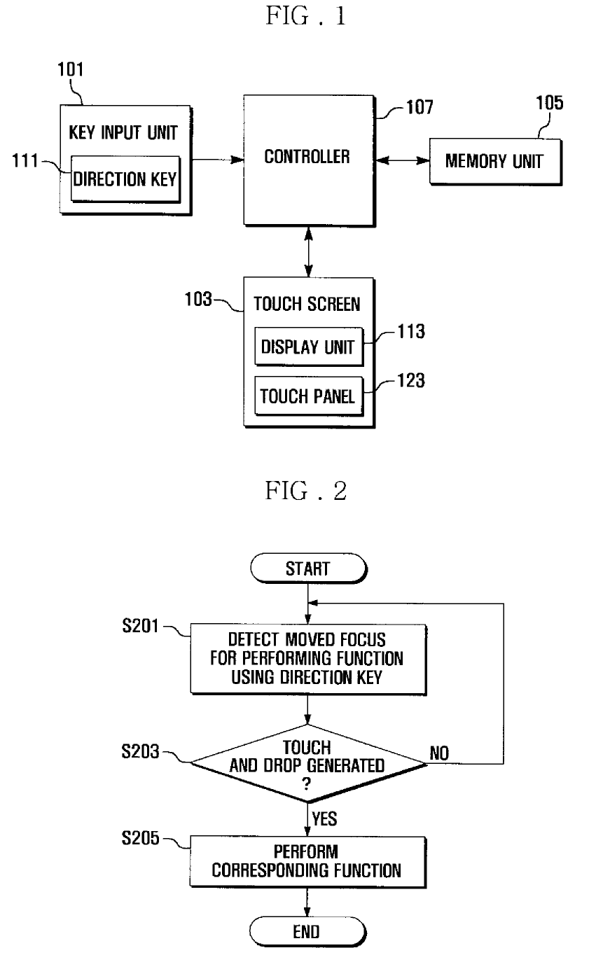

FIG. 1 is a block diagram illustrating one exemplary configuration of a terminal having a touch screen for performing a function according to an exemplary embodiment of the present invention.

Referring to FIG. 1, the terminal typically includes a key input unit 101, touch screen 103, memory unit 105, and controller 107.

The key input unit 101 receives a user's manipulation signal for controlling operation of the terminal. The key input unit 101 includes a direction key 111. The direction key 111 is a navigation key for vertically and horizontally moving a focus displayed on the touch screen 103. The key input unit 101 receives a user manipulation such as movement of a focus using the direction key 111 according to the present exemplary embodiment.

The touch screen 103 typically includes a display unit 113 and touch panel 123. The display unit 113 displays a status of the terminal. The display unit 113 may use, for example, a liquid crystal display (LCD) and may include an LCD controller, a memory for storing display data, and an LCD display element. The touch panel 123 may be mounted, for example, in one surface of the display unit 113 and includes a touch sensor and signal converter. The touch sensor, when a touch is generated, detects generation of the touch by detecting a change of a physical quantity, for example resistance and capacitance according to generation of the touch. Further, a signal converter converts the change of a physical quantity to a touch signal.

Still referring to FIG. 1, the touch screen 103 displays a screen for performing a function selected by the user. The touch screen 103 displays, for example a scheduler on a standby screen, or displays, when the scheduler is selected, additional functions provided in the scheduler in a list format.

The memory unit 105 typically stores a program and information required for operation of the terminal. The memory unit 105 stores several kinds of functions provided in the terminal.

The controller 107 controls general operations of the terminal. The controller 107 controls the terminal so as to perform a function according to the present exemplary embodiment. The controller 107 detects movement of a focus from use of the direction key 111 of the key input unit 101 for performing a function. In other words, the controller 107 determines whether the movement of a focus (by the user) for performing a function has been performed using the direction key 111. When the determination is affirmative, the controller 107 then determines whether a touch has been generated for performing a function corresponding to a position to which the focus has been moved. If a touch for performing a function corresponding to a position to which the focus is moved has been generated, the controller 107 controls the terminal to perform the corresponding function. Here, the touch comprises a touch and a drop and indicates an action in which the user touches the touch screen 103, then immediately releases the touch.

In accordance with the aforementioned paragraph, if a touch and drop is generated when the focus is moved (shifted) using the direction key 111, irrespective of the location of where in/along the touch screen 103 the touch and drop is generated, the controller 107 recognizes generation of the touch and drop in any area of the touch screen 103 as a signal for performing a function corresponding to a position to which the focus is moved. In other words, when the focus for performing a function is moved by using the direction key 111, if a touch and drop is generated within any area of the touch screen 103, the controller 107 controls to perform a function corresponding to the position to which the focus is moved.

The terminal further includes a radio frequency (RF) unit (not shown) for performing a wireless communication function. The RF unit includes an RF transmitter for up-converting a frequency of a signal to be transmitted and amplifying the signal, and an RF receiver for low-noise amplifying a received signal and down-converting a frequency of the signal.

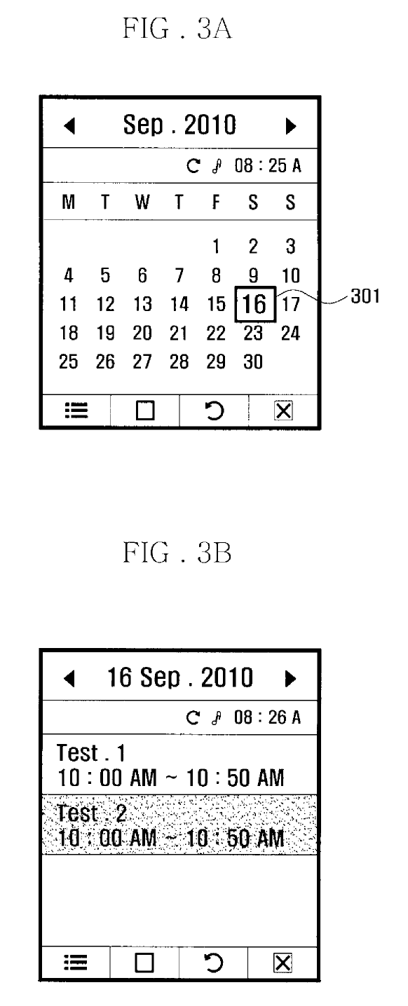

FIG. 2 is a flowchart illustrating a method of performing a function of a terminal according to another exemplary embodiment of the present invention. FIGS. 3A and 3B are diagrams illustrating non-limiting examples of a screen for performing a specific function in accordance with the method of FIG. 2.

Referring to FIGS. 1, 2, 3A, and 3B, the controller 107 detects movement of a focus using the direction key 111 for performing a function (S201). The user shifts a focus along the screen via the direction key 111 in order to perform a specific function, thereby selecting the corresponding function. A screen in which the focus is shifted using the direction key 111 is shown in FIG. 3A.

FIG. 3A illustrates an example of a screen in which a desired date 301 is selected using the direction key 111 in a scheduler.

In accordance with FIGS. 2 and 3A, the controller 107 determines whether a touch and drop is generated in any area of the touch screen 103 (S203). When the user shifts a focus using the direction key 111 in order to perform a function corresponding to the position to which the focus is moved, a touch and drop can be generated within any area of the touch screen 103. Thereby, a signal for performing a function corresponding to a position to which the focus is moved within a narrow area of the touch screen 103 can be easily input.

If a touch and drop is generated, then at step (S205) the controller 107 provides controls to perform a corresponding function. An example of a screen in which the corresponding function may be performed due to generation of the touch and drop is shown in FIG. 3B. When the focus 301 is moved to a specific date of the scheduler using the direction key 111 as shown in FIG. 3A, if a touch is generated within any area of the touch screen 103, information corresponding to the specific date is displayed, as shown in FIG. 3B. In the present exemplary embodiment, when the focus is shifted using the direction key 111, if the touch and drop is generated within any area of the touch screen 103, a function corresponding to the position to which the focus is moved is performed, however the prevent invention is not limited thereto. The function can be released or set by the user.

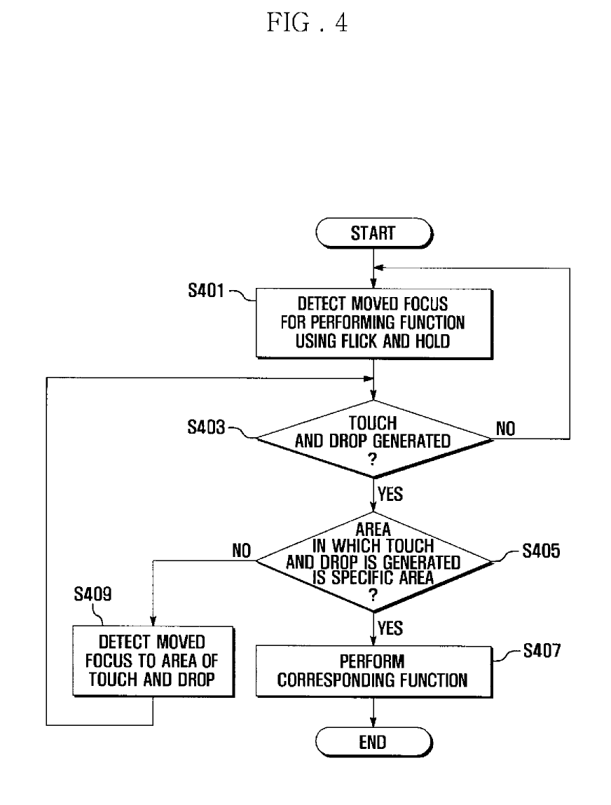

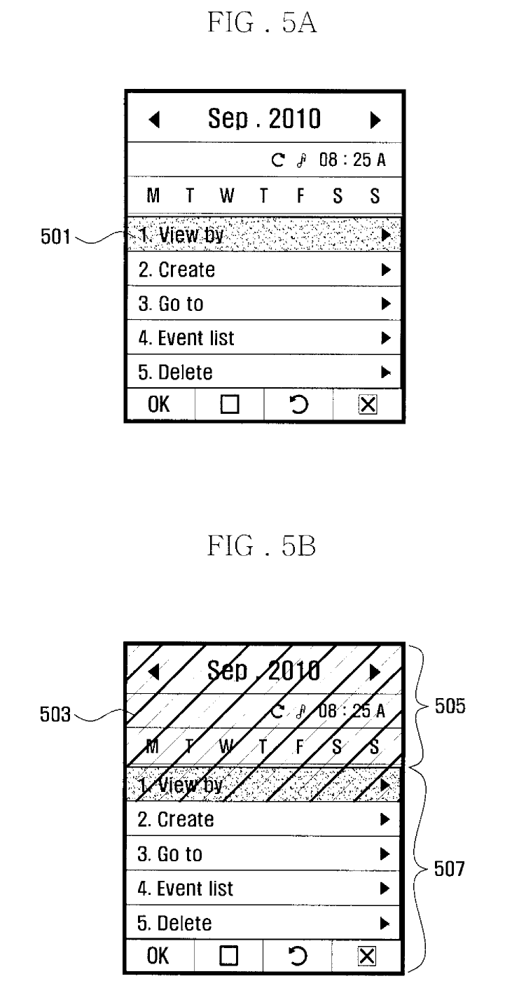

FIG. 4 is a flowchart illustrating examples of another method of performing a function of a terminal according to an exemplary embodiment of the present invention. FIGS. 5A and 5B are diagrams illustrating a screen for performing a specific function in the method of FIG. 4.

In this exemplary embodiment, the controller 107 detects movement of a focus for performing a function using a touch, for example, by a flick and hold. The flick and hold indicates an action in which the user quickly moves a finger or a stylus on the touch screen 103, then stops and holds the finger or stylus on the touch screen 103, similar to drawing a line.

More particularly, the controller 107 determines whether a touch and drop for performing a function corresponding to a position to which the focus is moved is generated, and controls, if an area in which the touch and drop is generated is a specific area, to perform a corresponding function.

The specific area (503 of FIG. 5B) is an area that includes the position to which the focus is shifted (501 of FIG. 5A) and an idle area (505 of FIG. 5B). The idle area indicates an area of the touch screen in which no function is performed, that is the area 505 of the touch screen that is not an area for performing a function within the touch screen(507 of FIG. 5B). In other words, the idle area is an area in the touch screen in which no function is to be performed even if a touch is generated at any position within the touch screen. Therefore, when the focus is shifted using a flick and hold, if a touch and drop is generated within a specific area, the controller 107 recognizes generation of the touch and drop as a signal for performing a function corresponding to a position to which the focus has shifted.

Referring to FIGS. 1, 4, 5A, and 5B, the controller 107 detects movement of a focus for performing a function using a first touch, for example, by a flick and hold (S401). The user moves a focus using a flick and hold with a finger or a stylus, thereby selecting a corresponding function. A screen in which the focus is moved using a flick and hold is shown in FIG. 5A.

FIG. 5A shows a screen in which a desired menu 501 is selected in a scheduler.

The controller 107 determines whether a second touch, for example, a touch and drop, is generated on the touch screen 103 (S403).

If a second touch, for example, a touch and drop, is generated, the controller 107 determines whether an area in which the touch and drop is generated is a specific area (S405). The specific area is an area including a position to which the focus is moved and an idle area, as described above. A screen for displaying a specific area 503 is shown in FIG. 5B. The user can generate a touch and drop within the specific area 503 including the position 501 to which the focus is moved and the idle area 505 in order to perform a function corresponding to the position 501 to which the focus is moved.

If an area in which the touch and drop is generated is a specific area, the controller 107 controls to perform a corresponding function (S407). In the present exemplary embodiment, when the focus is moved using a flick and hold, if a touch and drop is generated in one of an area including a position to which the focus of the touch screen 103 is moved and an idle area, a function corresponding to the position to which the focus is moved is performed, however the present invention is not limited thereto. The function can be released or set by the user.

If an area in which the touch and drop is generated is not a specific area at step S405, the controller 107 controls the movement of the focus to the area in which the touch and drop is generated (S409). In other words, if a touch and drop is generated in an area other than an area including a position to which the focus is moved and an idle area, the controller 107 controls movement of the focus to the area in which the touch has been generated. Thereafter, the process returns to step S403.

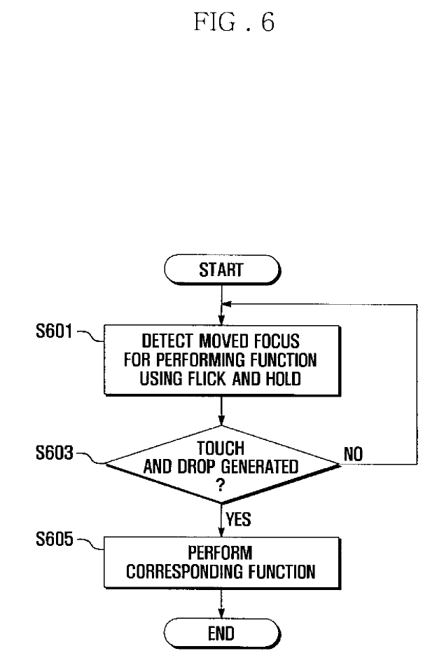

FIG. 6 is a flowchart illustrating examples of another method of performing a function of a terminal according to another exemplary embodiment of the present invention.

In this exemplary embodiment, the controller 107 detects movement of a focus for performing a function using a first touch, for example a flick and hold. In this case, the controller 107 determines whether a second touch, for example, a touch and drop, for performing a function corresponding to a position to which the focus is moved is generated, and controls, if a second touch is generated, to perform a function corresponding to the position to which the focus is moved.

When the focus for performing a function is moved using a flick and hold, if a touch and drop is generated, irrespective of where in the touch screen 103 the touch and drop is generated, the controller 107 recognizes generation of the touch and drop in any area of the touch screen 103 as a signal for performing a function corresponding to the position to which the focus is moved.

Referring to FIGS. 1 and 6, the controller 107 detects movement of a focus for performing a function using a first touch, for example a flick and hold (S601). The user moves the focus using a flick and hold in order to identify a specific function to be performed, thereby selecting the corresponding function.

The controller 107 determines whether a second touch, for example, a touch and drop, is generated in any area of the touch screen 103(S603). When the user moves the focus using a flick and hold in order to perform a function corresponding to the position to which the focus is moved, a touch and drop can be generated within any area of the touch screen 103. Therefore, a signal for performing a function corresponding to a position to which the focus is moved within a narrow area of the touch screen 103 can be easily input and detected.

If a second touch, for example, a touch and drop is generated, the controller 107 controls to perform a corresponding function (S605). In the present exemplary embodiment, when a focus is moved using a flick and hold, if a touch and drop is generated within any area of the touch screen 103, a function corresponding to the position to which the focus is moved is performed, however the prevent invention is not limited thereto. The function can be released or set by the user.

As described in the examples above, according to the present invention, because the detection of a touch for performing a function can be generated in a greater area of a terminal having a touch screen, generation of erroneous operation due to a small size of the touch screen can be avoided, thereby improving user convenience.

Although exemplary embodiments of the present invention have been described in detail hereinabove, it should be clearly understood that many variations and modifications of the basic inventive concepts herein taught which may appear to those skilled in the present art will still fall within the spirit of the present invention and the scope of the appended claims. For example, the direction key may comprise a key separate from the display, or may comprise a soft key or displayable key function.

What is claimed is:

1. A method of performing a function of a terminal having a touch screen, comprising:
detecting movement of a focus from a first position to a second position for performing a particular function; and
performing the particular function corresponding to said second position associated with the focus in response to detecting a touch being generated on the touch screen.

2. The method of claim 1, wherein the detection of the movement of the focus for performing the particular function comprises: detecting movement from actuation of a direction key; and said performing of the particular function corresponding to the second position to which the focus is moved only if said touch is detected within any area of the touch screen.

3. The method of claim 2, wherein the detected touch generated within any area of the touch screen comprises a touch and drop action, then said performing of the particular function corresponding to said second position occurs after detecting release of the touch from the touch screen.

4. The method of claim 1, wherein detecting movement of a focus for performing the particular function comprises detecting movement of the focus caused by a first touch; and said performing said particular function corresponding to said second position occurs if detection of a second touch is generated in at least one of the second position to which the focus is moved and an idle area.

5. The method of claim 4, wherein said first touch for moving the focus for performing the function comprises a flick and hold action generated by detecting movement of the touch along the touch screen, then detecting stopping of the movement without detecting release of the touch from the touch screen; and the second touch comprises a touch and drop action generated by detecting touching of the touch screen, then detecting release of the touch from the touch screen.

6. The method of claim 4, wherein the idle area comprises an area of the touch screen that does not have any corresponding functions associated therewith.

7. The method of claim 1, wherein detecting movement of the focus for performing the function comprises: detecting movement of the focus caused by a first touch; and performing a function corresponding to the second position to occurs if the second touch is generated within any area of the touch screen.

8. The method of claim 7, wherein said first touch for moving the focus for performing the function comprises a flick and hold action generated by detecting movement of the touch on the touch screen, then stopping without detecting a release of the touch from the touch screen; and the second touch comprises a touch and drop action generated by detecting touching of the touch screen, then detecting a release of the touch from the touch screen.

9. The method of claim 2, wherein the direction key comprises a soft key.

10. The method of claim 2, wherein the direction key comprises a function key displayed on the touch screen.

11. A terminal comprising:
a touch screen; and
a controller for controlling movement of a focus for performing a function and if detecting a touch generated on the touch screen, for performing a function corresponding to a detected position of the focus.

12. The terminal of claim 11, further comprising a key input unit comprising a direction key for moving the focus, and wherein the controller controls performing of the particular function if the movement of the focus is detected and a touch is detected within any area of the touch screen.

13. The terminal of claim 12, wherein the key input unit comprises a soft key.

14. The terminal of claim 12, wherein the key input unit comprises a function key displayed on the touch screen.

15. The terminal of claim 11, wherein the detected touch generated within any area of the touch screen comprises a touch and drop action generated by detecting a touching of the touch screen followed by detecting a releasing of touch from the touch screen.

16. The terminal of claim 11, wherein detecting of movement of the focus includes detecting a first touch, and the controller controls performing the function, if detecting of a second touch is generated in at least one of the position in which the detecting of movement of the focus has occurred and an idle area.

17. The terminal of claim 16, wherein the first touch for detecting movement of the focus comprises a flick and hold action generated by detecting a movement of the touch on the touch screen, followed by detecting a stopping of movement without detecting a release of the touch from the touch screen; and the second touch comprises a touch and drop action generated by detecting a touching of the touch screen, and then detecting a release of the touch from the touch screen.

18. The terminal of claim 17, wherein the idle area comprises an area of the touch screen that does not have any corresponding functions associated with performing a function within the touch screen.

19. The terminal of claim 12, wherein the detecting of the movement of the focus comprises detecting a first touch on the touch screen, and the controller controls performing the function if a second touch is generated within any area of the touch screen.

20. The terminal of claim 18, wherein the detecting of the first touch of movement of the focus comprises a flick and hold action generated by detecting movement of touch on the touch screen, followed by detecting a stopping of the movement without detecting a release of the touch from the touch screen; and the second touch comprises a touch and drop action generated by detecting touching of the touch screen, then detecting a release of the touch from the touch screen.
